(19) United States
(12) Patent Application Publication
(10) Pub. No.: US 2002/0103667 A1
(43) Pub. Date: Aug. 1, 2002

(54) System and process for securitizing payments to third parties

(76) Inventors: Shekar Jannah, Forest, VA (US); Thomas Burt Hazelwood, Richmond, VA (US); Oscar Tengtio, Richmond, VA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/059,202

(22) Filed: Jan. 31, 2002

Related U.S. Application Data
(60) Provisional application No. 60/265,086, filed on Jan. 31, 2001.

(51) Int. Cl. G06F 17/60

(52) U.S. Cl. 705/1

(57) ABSTRACT

A method and system for securitization of periodic streams of payments is provided. The system and method comprise generating a sale of the insurance policy and investment related products from an insurance issuer component through an agent component. The insurance issuer component pays the agent component a commission via a periodic streams of payments, which the agent component sells to a securitization component. The securitization component generates a securitization note based on the periodic streams of payments, including such factors as lapsation and mortality.

### FIELD OF THE INVENTION

The present invention relates generally to a system and process for securitizing commission payments, and more particularly for securitizing commission payments to third parties, such as individual insurance agents, brokers, banks, financial institutions, distributors, and the like.

### BACKGROUND OF THE INVENTION

It is known in the financial industry how to securitize various types of assets to allow them to be bought and sold in a market. For example, auto loans, mortgages, leases, and other assets with cash flows may be securitized according to the cash flow of the particular asset and the risk associated with that asset.

Companies often sell products through third parties (e.g., individual insurance agents, brokers, banks, financial institutions, distributors, etc.)(hereinafter referred to as “agents” or “agent components”). For example, insurance companies often use agents to sell insurance policies and other investment related products. Agents may be paid according to various manners, such as a year salary, commissions based on sales of products (e.g., insurance policies, investment related products, etc.), monthly payments supplemented by commissions, and/or other manners. These payment situations may often require the insurance company to maintain cash reserves, thereby tying up capital that may be used for other business purposes.

FIG. 1 is a schematic representation of the payment flow for a conventional commission payment in the context of an insurance policy. An individual insurance policy holder 110 purchases an insurance policy from insurance company 120, through agent 130. Individual insurance policy holder 110 receives the insurance policy contract from the insurance company 120 at 140 in exchange for policy premium payments at 150. As is known in the art, agent 130 receives a lump sum commission at 160 from insurance company 120. Often, this lump sum commission is a percentage of the premiums received from the individual policy holder 110.

These and other drawbacks exist.

### SUMMARY OF THE INVENTION

One goal of the present invention is to overcome these and other drawbacks in existing systems and methods.

It may also be desirable to provide a system and process for securitizing payments to third parties.

A further goal is of the present invention is to provide a system and methodology for securitizing a periodic stream of commission payments to a third party agent.

To achieve these and other features of the invention, a company may substitute a lump sum payment with a periodic payment stream to an agent. The agent sells the periodic payment stream to a third party in exchange for a lump sum payment. The third party may issue a securitized note based on the periodic stream of payments received from the company.

Other objects and advantages exist for the present invention.

### BRIEF DESCRIPTION OF THE DRAWINGS

FIG. 1 is schematic representation of a system for conventional commission payments.

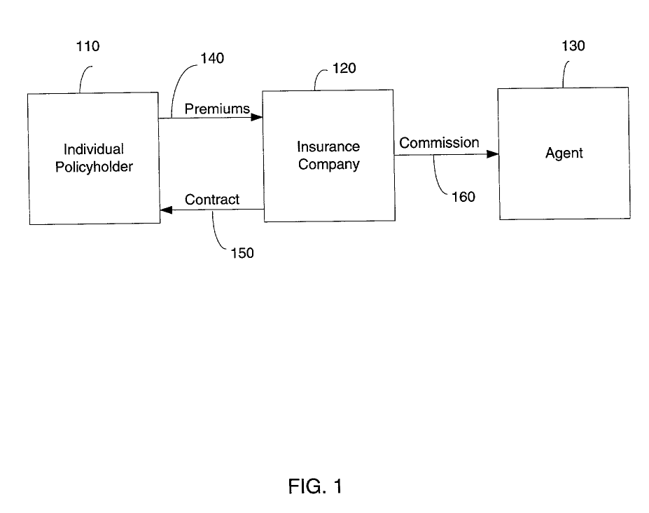

FIG. 2 is schematic representation of a system for securitizing periodic payment streams according to one embodiment of the present invention.

FIG. 3 is a flowchart illustrating a process for securitizing periodic payment streams according to one embodiment of the present invention.

FIG. 4 is an example of one possible structure for a graphic user interface for securitization of periodic payment streams according to one embodiment of the invention.

### DETAILED DESCRIPTION OF THE PREFERRED EMBODIMENTS

The present invention is described in relation to systems and processes for the securitization of periodic payment streams based on commissions for selling insurance policies. Nonetheless, the characteristics and parameters pertaining to the systems and processes may be applicable to other types of securitizations, including securitizations of payments for other financial instruments and to other aspects of insurance policies, as well as periodic payment streams based on commissions for other types of products, such as investment related products.

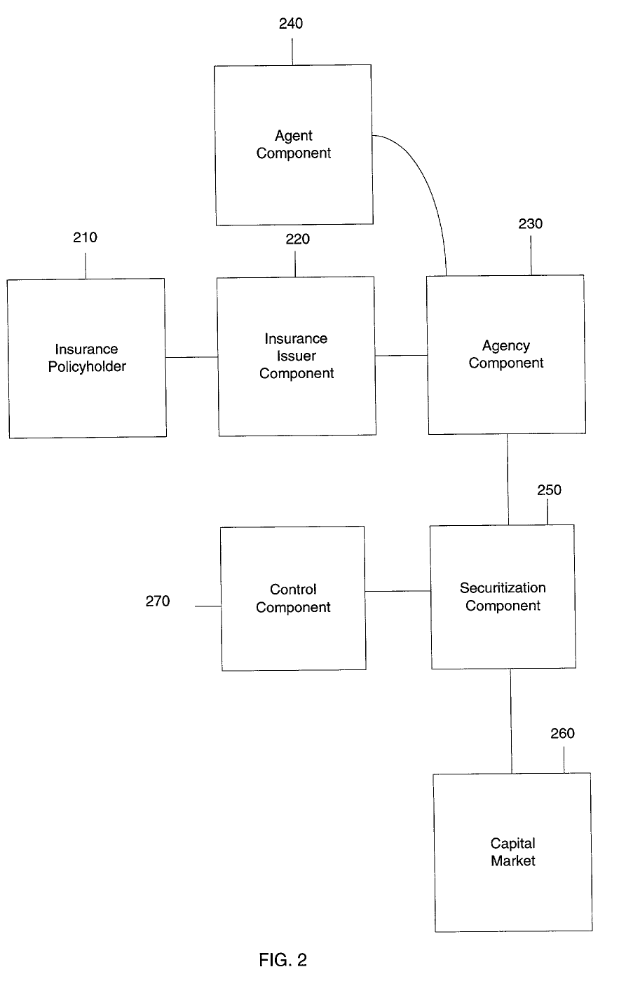

FIG. 2 is a schematic representation of a system for implementing an embodiment of the invention. According to an embodiment of the invention, the system may comprise insurance policy holders 210, insurance issuer component 220, agency component 230, agent component 240, securitization processing component 250, capital market 260, and control component 270. For illustration purposes only, the present invention, FIG. 2 depicts one policy holder 210, one insurance issuer component 220, one agency component 230, one agent component 240, one securitization component 250, capital market component 260, and control component 270. However, any number of policy holders 210, insurance issuer components 220, agency components 230, agent components 240, securitization components 250, capital market components 260, and control components 270 may be employed in connection with the implementation of the present invention. According to an embodiment of the invention, one securitization component 250 may communicate with a plurality of agency components 230. According to an embodiment of the invention, an agency component 230 may communicate with a plurality of securitization components 250. Other configurations may also be used, such as, but not limited to, a plurality of agency components 230 and a plurality of securitzation components 250.

As illustrated in FIG. 2, various components may interact with other components by transmitting information between components via network connections, such as, for example, intranet connections, internet connections, satellite connections, dial-up access lines or the like. According to a preferred embodiment of the invention, components may be connected in a network configuration to form a system of components, where components interact with each other by exchanging data and initiating transactions.

Policy holders 210 may purchase life insurance from insurance issuer component 220. According to an embodiment of the invention, policy holder 210 may purchase insurance (or other products, such as investment related products) from insurance issuer component 220 through agent component 240. Purchases of an insurance policy may be performed via the internet or by a more conventional method such as calling or visiting an insurance agent. Policy holder 210 pays insurance issuer component 220, such as by paying policy premium proceeds in exchange for the insurance policy contract. Insurance issuer component 220, by way of example, may be implemented as software running on a personal computer which is preferably networked with other computers. Insurance issuer component 220 may service an insurance policy purchased by insurance policy holder 210. Insurance policy servicing may include collecting premium payments, processing claims, calculating a daily cash surrender value for a policy, including tracking premiums paid, compounding interest and adding interest when due and other known servicing of insurance policies.

According to an embodiment of the invention, insurance issuer component 220 may be a computer program used by a corporate entity, such as an insurance company. According to an embodiment of the invention, insurance issuer component 220 may be software operated by an insurance company licensed to provide insurance in one state. Other entities involved in the overall transaction may also be included, in accordance with applicable federal, state, and local laws and regulations.

According to an embodiment of the invention, as an insurance policy holder 210 pays premiums toward an insurance policy, insurance issuer component 220 may pay a commission to agency component 230 through a periodic stream of payments. Agent component 240 may be appointed by agency component 230 to sell products of insurance issuer component 220. According to an embodiment of the invention, agency component 230 may be a company which appoints agent component 240. Payments may be made on a periodic basis (e.g., monthly, yearly, etc.) as agreed to by the insurance issuer component 220 and the agency component 230. Thus, in exchange for the selling the insurance policy to policyholder 210, agency component 230 receives the payments from insurance issuer component 220. Other payment structures may also be used.

The agency component 230 may own the periodic payment stream as an asset. Agent component 230 may cause the sale of a periodic payment stream to securitization component 250 in exchange for cash and/or equity. According to an embodiment of the invention, the cash received in exchange for the periodic payment stream may be the equivalent to the amount the agent component 230 would have received if insurance issuer 220 had made a lump sum payment to the agent component 230. The costs required may be paid by agency component 230 to agent component 240. This amount may be equal to the amount agent component 240 would have received if agency component 230 paid a lump sum amount. According to an embodiment of the invention, securitization component 250 may be computer software running on a computer which is networked with other computers and is used by a subsidiary partially owned by the company operating insurance issuer component 220.

According to another embodiment of the invention, securitization component 250 may be computer software running on a computer which is networked with other computers and used by a company owned by insurance issuer component 220. Thus, according to the example illustrated in FIG. 2, securitization component 250 may be a computer program used by a corporation partially owned by a company using insurance issuer component 220. Other forms of securitization components 250 may also be used, as well as other ownership configuration.

Thus, by way of example, agency component 230 may sell its perfected assignable future cash flow to a securitization processing component 250 in exchange for a cash payment. Agency component 230 retains no risks or rewards to this stream of cash flows and does not guarantee the securitization process component 250 any specified return on the cash proceeds.

The company using securitization processing component 250 may receive the periodic payment stream, and may treat the periodic payment streams as assets. According to an embodiment of the invention, securitization processing component 250 may cause one or more securitization notes to be issued based on, and backed by, the periodic payment streams. Actuarial computations embodied in computer programs may enable the issuer and purchaser of the securitization to project appropriately lapsation and mortality for purposes of projecting principal payments to be made on the securitization note. A computer program may include standard actuarial methods known to those in the actuarial art.

Interest on the securitization note may be paid from the periodic stream of payments from insurance issuer component 220. According to an embodiment of the invention, in selling the periodic stream of payments, agency component 230 transfers the periodic stream of payments to securitization component 250, such that securitization component 250 receives the periodic stream of payments from insurance issuer component 220. Securitization component 250 uses the periodic stream of payments to pay interest on the securitized notes. Other manners of paying interest may also be used.

According to an embodiment of the invention, securitization component 250 may cause a securitized note to be issued to a company using commercial paper in exchange for cash. According to an embodiment of the invention, a commercial paper creating component (which may be part of securitization component 250) may be computer software running on a computer which is networked with other computers and is operated by a company. Commercial paper creating components may cause commercial paper to be issued based on the securitization note, and commercial paper to be sold on a commercial paper market, such as, for example, the U.S. commercial paper market. Issuing commercial paper based on the securitization note may be similar to issuing commercial paper based on other securitized assets. As related to the example of FIG. 2, commercial paper creating component may be a computer program used by a company which issues commercial paper based on securitization notes, which in turn may be based on periodic streams of payments based on commissions from insurance issuer component 220. The company operating the commercial paper creating component may designate a commercial paper agent to sell commercial paper to the commercial paper market. Other configurations may also be used.

Thus, by way of example, securitization processing component 250 issues one or more securitized notes to capital market 260. The securitized note is issued to capital market 260 via note and/or commercial paper which is collateralized by the commissions payment stream in order to raise cash for purchase of the related commission cash flow stream. Future cash flows collateral will be used to retire the securitized note.

Various services may be needed by securitization component 250 and a commercial paper creating component. According to an embodiment of the invention, control component 270 may provide operating services, such as maintaining records of transactions, and assisting in financial transactions. Control component 270 may also handle collateral for transactions performed by commercial paper creating component 250. Further, control component 270 may issue letter of credit for a commercial paper creating component. According to an embodiment of the invention, control component 270 may issue a letter of credit for a commercial paper creating component as required by a rating agency. Control component 270 may provide services to provide liquidity for a commercial paper creating component to interact with the market. Other services may also be provided. Thus, by way of example, control component 270 acts as liquidity agent and as guarantor of the securitization note.

A company may also use a swap processing component (not shown) to allow a commercial paper creating component to exchange obligations of different types of interest rates. A swap processing component creates a swap which exchanges variable cash flows for fixed cash flows. According to an embodiment of the invention, a company operating a commercial paper creating component may exchange an obligation to pay a variable interest rate for an obligation to pay a fixed interest rate with a company operating a swap processing component in each case based on one or more notional principal balances. Other services may also be provided by a swap component.

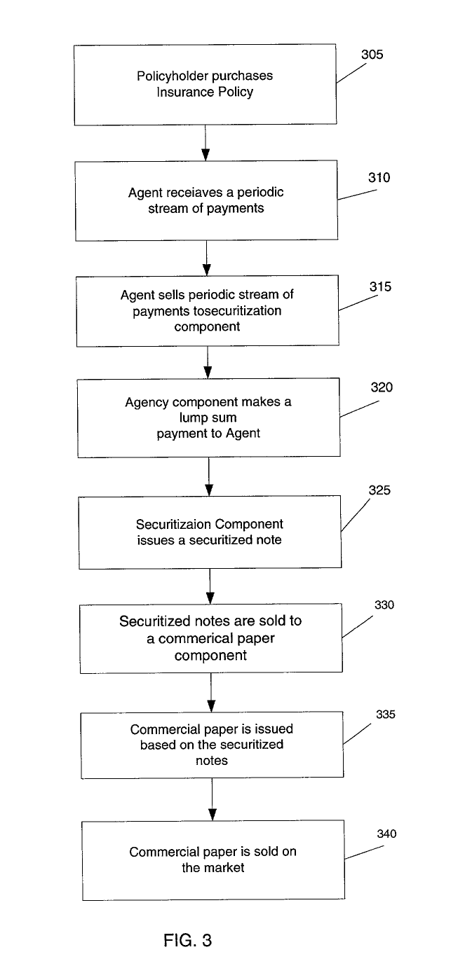

FIG. 3 is a flow chart of a method according to an embodiment of the present invention, whereby the system of FIG. 2 may be implemented. At step 105, an insurance policy holder 210 may purchase an insurance policy from insurance issuer component 220, through agency component 230. At step 310, insurance issuer component 220 begins a periodic stream of payments to agency component 230 as a commission based on the sale of the insurance policy.

At step 315, agent component 230 causes a lump sum payment to be made to agent component 240. At step 320, agency component 230 causes the sale of the periodic stream of payments to a company using securitization component 250 and for cash and/or equity. According to an embodiment of the invention, securitization component 250 is operated by a limited liability company (LLC), or other form of corporate entity, which may be partially owned by the company operating insurance issuer component 220.

Securitization component 250 may cause to be issued securitization notes based on the periodic stream of payments at step 325. A securitization note may be based on various factors, including the amount of the each of the periodic payments, as well as on the mortality and lapsation rates of the underlying insurance policies.

At step 330, securitization component 250 may cause the sale of securitization notes to a company operating a commercial paper creating component for cash and/or equity. According to an embodiment of the invention, a commercial paper creating component may be used by an issuer of commercial paper. At step 335, commercial paper may be issued based on the securitization notes, and may cause the commercial paper to be sold at step 340. The commercial paper may be sold on the U.S. commercial paper market for cash. Other embodiments of the invention may also be used.

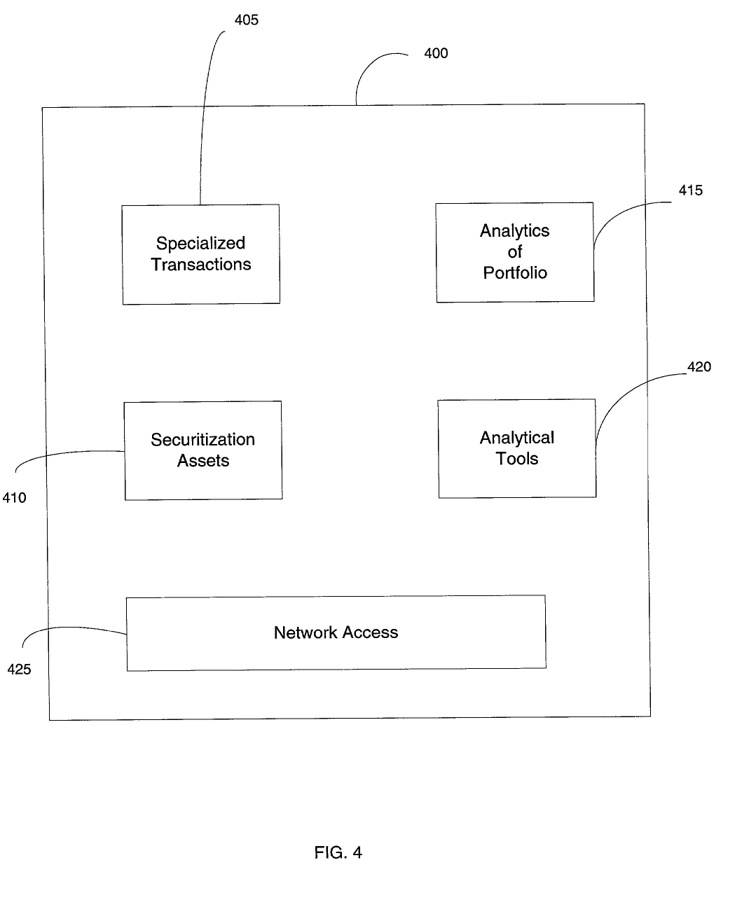

FIG. 4 illustrates one possible overall structure for a graphic user interface 400 that may be presented to a user for securitization of periodic payment streams. According to an embodiment of the invention, graphic user interface 400 may be presented to a user of securitization component 240. Graphic user interface 400 presents various information and tools to a user, where the information and tools may relate to management of securitized periodic streams of payments, such as payments for commissions, as well as other assets. However, graphic user interface 400 may be used in connection with other components of the system.

According to an embodiment of the invention, graphic user interfaces may display specialized transactions 405, securitization assets 410, portfolio 415, tools 420, and network access 425. Specialized transactions 405 may provide information about special financial transactions, including asset information, such as the current value of the assets, and the asset performance. Specialized transactions may include transactions with certain tax implications, ownership implications, or other predetermined implications to a securitization component 240.

Securitization assets 410 may provide information about general securitization assets, including securitized periodic streams of payments. Information may include the cash flow of the asset, the lapsation and mortality vectors, and the collateral associated with the asset. Thus, in the context of securitization of periodic streams of payments, information may include the payment schedule of the periodic stream, the lapsation of the insurance policy or investment related products, and other factors. Other information may also be presented.

Portfolio 415 may present information about a current portfolio of assets, including securitized periodic payment streams. Information may include the current cash flow of the assets, the value of the assets, the performance of the assets relative to alternatives, and other information. According to an embodiment of the invention, portfolio 415 may present information about a portfolio of periodic payment streams, including the cash flow and value of the periodic payment streams, the rate of return on the securitized periodic payment streams in comparison to U.S. Treasury bills or comparable financial instruments, the aggregate value of periodic payment streams, the amount repaid due to lapsation, the amount repaid due to mortality and other information. Other information may also be presented by portfolio 415.

Tools 420 may present a user with tools to analyze various assets for securitization, including periodic payment streams. Tools 420 may allow a user to create various scenarios with a particular asset and determine cash flow, performance, and value of the asset based on the scenario. According to an embodiment of the invention, tools 420 may permit a user to determine the cash flow and value of a securitzation of a periodic payment stream based on various factors, including mortality, lapsation, and other factors. Tools 420 may present other tools.

Network access 425 may allow a user to access various network connections. Network connections may include the internet, an intranet, dial-up connections, satellite networks, or other connections between securitization component 240 and other components or other systems. Network access 430 may permit a user to interact with other computers and perform various activities associates with collection of payments, payment of taxes, auditing records, monitor transactions, and provide information. Other interaction and activities may also be performed.

Other embodiments of graphic user interface 400 may also used, either in connection with securitization component 250, or with other components of the system. Other configurations, information, tools, and applications may also be associated with graphic user interface 400.

Creating a securitization note from the periodic streams of payments may allow an insurance issuer component 220 to reduce the amount of capital need to make lump sum commission payments to agency component 230. Insurance issuer 220 may provide smaller payments over a period of time, thereby reducing the capital tied up in commission payments. Agency component 230 may receive an equivalent commission by selling the periodic streams of payments to securitization component 250. Thus, the process may be transparent to agency component 230, in that the commission received by agency component 230, and paid to agent component 240, is the same whether the commission payment by insurance issuer component 220 is made as a lump sum or as a periodic stream of payments. Securitizing the payments may enable the insurance issuer component 220 to achieve greater liquidity and free capital for other uses by insurance issuer component 220.

Creating a securitization note from the periodic streams of payments may also allow the company using a commercial creating paper component to issue commercial paper based on the securitization note, and accordingly on the periodic payment streams, and may be counted on to provide funding at prevailing highly rated debt securities interest rates. Issuing commercial paper provides a vehicle for periodic payment streams to have enhanced liquidity and broader market acceptance. Securitization of periodic streams of payments may enable periodic streams of payments to be more easily bought and sold.

Further, the present invention allows for a program to acquire periodic streams of payments, or securitized notes based on periodic streams of payments, from other insurers. An acquiring insurance company may transform the periodic streams of payments to securitization notes and then to commercial paper, thereby maintaining liquid assets.

By way of example, securitizing a periodic stream of payments in the insurance industry may establish an off balance sheet commission funding vehicle to reduce statutory capital strain, and allow for growth in production of current and future product lines. Specifically, statutory capital strain (e.g., capital levels mandated by state statute) may be reduced for initial first year lump sum commission payments. For some products, commissions paid on the initial year premium may create negative statutory income and capital constraint. Spreading the commission payments over future years, and making the commission payments contingent on non-lapsation of the underlying insurance policy may facilitate smoothing of the statutory expense. Further, the assessed cost of funds and the interest expense may be reduced due to the change from an initial lump cash sum payment to a series of cash payments. These advantages may be available for other industries as well.

According to another embodiment of the invention, a computer usable medium having computer readable program code embodied therein for an electronic computation may be provided. For example, the computer usable medium may comprise a CD ROM, a floppy disk, a hard disk, or any other computer usable medium. One or more of the components of the system may comprise computer readable program code that is provided on the computer usable medium such that when the computer usable medium is installed on a computer system, those components cause the computer system to perform the functions described.

According to one embodiment, insurance issuer component 220, agency component 230, agent component 240 securitization component 250, and control component 270 may comprise computer readable code that, when installed on a computer, perform the functions described above. Also, only some of the components may be provided in computer readable code.

Additionally, various entities and combinations of entities may employ a computer to implement the components performing the above described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

In the claims

1. A system for securitizing periodic payments to a party, the system comprising:
a processing component responsible for making periodic payments to a receiving component; and
a securitization component for:
a) purchasing the periodic payment stream from the receiving component; and
b) issuing at least one securitized note based on the periodic payment from the processing component.

2. The system of claim 1, further comprising a commercial paper creating component for issuing at least one commercial paper based on the at least one securitized note.

3. The system according to claim 1, futher comprising the processing component making periodic payments to a second receiving component, wherein the securitization component:
a) purchases the periodic payment stream from the second receiving component; and
b) issues at least one other securitized note based on the periodic payment from the processing component.

4. The system according to claim 2, wherein the commercial paper is sold on the commercial paper market.

5. The system according to claim 2, further comprising a swap processing component for exchanging variable interest rate obligations for fixed interest rate obligations or fixed interest rate obligations for variable interest rate obligations with the commercial paper creating component, wherein the exchange is based on the at least one commercial paper.

6. The system according to claim 2, further comprising a control component for providing services to the commercial paper creating component, the services comprising at least one of:
a) operating services;
b) collateral services;
c) credit services; and
d) liquidity services.

7. The system according to claim 1, where the processing component is an insurance company, the receiving component is an insurance agent, and the periodic payment is a periodic commission payment based on the sale of one or more insurance policies by the agent.

8. The system according to claim 7, wherein the at least one securitized note is issued based on acturial computations involving the lapsation and mortality of the policy holder.

9. A system for securitizing periodic commission payments to an insurance agent, the system comprising:
an insurance company component responsible for making a stream of periodic commission payments to the insurance agent based on the sale of one or more insurance policies by the insurance agent;
a securitization component for:
a) purchasing the periodic commission payments from the insurance agent; and
b) issuing at least one securitized note based on the periodic commission payments from the insurance company component; and
a commercial paper creating component for issuing at least one commercial paper based on the at least one securitized note.

10. The system according to claim 9, further comprising the insurance company component making periodic commission payments to a second insurance agent based on the sale of one or more insurance policies by the insurance agent, wherein the securitization component:
a) purchases the periodic commission payments from the second insurance agent; and
b) issues at least one other securitized note based on the periodic payment from the insurance company component.

11. The system according to claim 9, wherein the commercial paper is sold on the commercial paper market.

12. The system according to claim 9, further comprising a swap processing component for exchanging variable interest rate obligations for fixed interest rate obligations or fixed interest rate obligations for variable interest rate obligations with the commercial paper creating component, wherein the exchange is based on the at least one commercial paper.

13. The system according to claim 9, further comprising a control component for providing services to the commercial paper creating component, the services comprising at least one of:
a) operating services;
b) collateral services;
c) credit services; and
d) liquidity services.

14. The system according to claim 9, wherein the at least one securitized note is issued based on acturial computations involving the lapsation and mortality of the policy holder.

15. A process for securitizing periodic payments to a party, the process comprising:
receiving periodic payments from a processing component; and
selling the periodic payments to a securitization component, where the securitzation component issues at least one securitized note based on the periodic payment from the processing component.

16. The process of claim 15, wherein a commercial paper creating component issues at least one commercial paper based on the at least one securitized note.

17. The process according to claim 16, wherein the commercial paper is sold on the commercial paper market.

18. The process according to claim 16, wherein a swap processing component exchanges variable interest rate obligations for fixed interest rate obligations or fixed interest rate obligations for variable interest rate obligations with the commercial paper creating component, wherein the exchange is based on the at least one commercial paper.

19. The process according to claim 15, wherein a control component provides services to the commercial paper creating component, the services comprising at least one of:
a) operating services;
b) collateral services;
c) credit services; and
d) liquidity services.

20. The process according to claim 15, where the processing component is an insurance company and the periodic payment is a periodic commission payment based on the sale of one or more insurance policies by the agent.

21. The process according to claim 20, wherein the at least one securitized note is issued based on acturial computations involving the lapsation and mortality of the policy holder.

22. A process for securitizing periodic commission payments to an insurance agent, the process comprising:
receiving periodic commission payments from an insurance company component based on the sale of one or more insurance policies; and
selling the periodic commission payments to a securitization component, wherein:
a) the securitzation component issues at least one securitized note based on the periodic payment from the processing component; and
b) a commercial paper creating component issues at least one commercial paper based on the at least one securitized note.

23. The process according to claim 22, wherein the commercial paper is sold on the commercial paper market.

24. The process according to claim 22, wherein a swap processing component exchanges variable interest rate obligations for fixed interest rate obligations or fixed interest rate obligations for variable interest rate obligations with the commercial paper creating component, wherein the exchange is based on the at least one commercial paper.

25. The process according to claim 22, wherein a control component provides services to the commercial paper creating component, the services comprising at least one of:
a) operating services;
b) collateral services;
c) credit services; and
d) liquidity services.

26. The process according to claim 25, wherein the at least one securitized note is issued based on acturial computations involving the lapsation and mortality of the policy holder.

27. A process for securitizing periodic payments to a party, the process comprising:
purchasing periodic payments from a receiving component, where the periodic payments are made by a processing component to the receiving component; and
issuing at least one securitized note based on the periodic payment from the processing component.

28. The process of claim 27, wherein the securitized note is sold to a commercial paper creating component issues at least one commercial paper based on the at least one securitized note.

29. The process according to claim 28, wherein the commercial paper is sold on the commercial paper market.

30. The process according to claim 28, wherein a swap processing component exchanges variable interest rate obligations for fixed interest rate obligations or fixed interest rate obligations for variable interest rate obligations with the commercial paper creating component, wherein the exchange is based on the at least one commercial paper.

31. The process according to claim 28, wherein a control component provides services to the commercial paper creating component, the services comprising at least one of:
a) operating services;
b) collateral services;
c) credit services; and
d) liquidity services.

32. The process according to claim 27, where the processing component is an insurance company and the periodic payment is a periodic commission payment based on the sale of one or more insurance policies by the agent.

33. The process according to claim 32, wherein the at least one securitized note is issued based on acturial computations involving the lapsation and mortality of the policy holder.

34. A process for securitizing periodic commission payments to an insurance agent, the process comprising:
purchasing periodic commission payments from an insurance agent, where the periodic commission payments are from an insurance company component based on the sale of one or more insurance policies; and
issuing at least one securitized note based on the periodic payment from the processing component, wherein a commercial paper creating component issues at least one commercial paper based on the at least one securitized note.

35. The process according to claim 34, wherein the commercial paper is sold on the commercial paper market.

36. The process according to claim 34, wherein a swap processing component exchanges variable interest rate obligations for fixed interest rate obligations or fixed interest rate obligations for variable interest rate obligations with the commercial paper creating component, wherein the exchange is based on the at least one commercial paper.

37. The process according to claim 34, wherein a control component provides services to the commercial paper creating component, the services comprising at least one of:
a) operating services;
b) collateral services;
c) credit services; and
d) liquidity services.

38. The process according to claim 34, wherein the at least one securitized note is issued based on acturial computations involving the lapsation and mortality of the policy holder.
